(19) United States
(12) Patent Application Publication
(10) Pub. No.: US 2016/0330699 A1
(43) Pub. Date: Nov. 10, 2016

(54) TRANSMISSION POWER FOR DEVICE-TO-DEVICE COMMUNICATION

(71) Applicant: INTEL CORPORATION, Santa Clara, CA (US)

(72) Inventors: Rongzhen Yang, Shanghai (CN); Hujun Yin, Saratoga, CA (US)

(21) Appl. No.: 14/353,983

(22) PCT Filed: Dec. 18, 2013
(86) PCT No.: PCT/US2013/076031

§ 371 Date: Apr. 24, 2014

(51) Int. Cl. H04W 52/38; H04W 52/36; H04W 52/24

(52) U.S. Cl. CPC H04W 52/383; H04W 52/242; H04W 52/241; H04W 52/367

(57) ABSTRACT

Generally discussed herein are systems and apparatuses that are configured to determine a transmission power to communicate with and techniques for determining the transmission power. According to an example a technique can include pairing a first UE with a second UE, receiving a reference signal, determining a Signal to Interference Ratio (SIR) of the received reference signal, receiving one or more power control parameters, and determining a decided transmission power as a function of the one or more power control parameters and the SIR.

### TECHNICAL FIELD

Examples generally relate to User Equipment (UE) and techniques for determining transmission power, and more specifically to determining a transmission power for Device-to-Device (D2D) communications between UEs communicating in a distributed or hybrid network communication system.

### TECHNICAL BACKGROUND

There are currently three different D2D communication architectures. In the centralized architecture an enhanced Node B (eNodeB) retains the full control of radio resources. In a distributed architecture User Equipment (UE) communicates with each other without eNodeB involvement. In a hybrid architecture a combination of the centralized and direct systems is used. That is, the eNodeB may have partial to full control of radio resources in some circumstances and the device may communicate with the eNodeB to get access to the radio resources, or a combination thereof, depending on the circumstances of the request.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of User Equipment (UE) communicating in a system.

FIG. 2 illustrates a block diagram of an example of a technique for determining a power level to communicate with.

FIG. 3 illustrates an example of a cellular network.

FIG. 4 is an example of a line graph of a sum of system Spectral Efficiency (SE) versus a maximum transmit power.

FIG. 5 is an example of a line graph of total power consumption versus maximum transmit power.

FIG. 6 illustrates an example of a technique for determining a transmission power.

FIG. 7 illustrates an example of a computing device.

### DESCRIPTION OF EMBODIMENTS

Examples in this disclosure relate to apparatuses and systems for transmission power control in D2D proximity communications. Examples also relate to techniques of using the apparatuses and systems.

In the current Long Term Evolution (LTE) standard development forecast, the Device-to-Device (D2D) communication is a field that can be enhanced for better performance. In implementing D2D, determining the power control is a key factor in performing interference coordination (e.g., Inter-Cell Interference Coordination (ICIC)) and system performance optimization.

The distributed and hybrid communication architectures are compatible with current cellular communication systems. Specifically, these models are used in current interference control and Radio Resource Management (RRM) systems. Thus, systems directed to these architectures can better support public safety and reduce the impact on existing operator services, as compared to a centralized architecture model.

In a distributed D2D system, the UE needs to both maintain a UE-to-UE (D2D) radio link and help reduce or minimize the interference to other UEs, such as through D2D communication or an eNodeB.

Reference will now be made to the drawings wherein like structures will be provided with like suffix reference designations. In order to show the structures of various examples clearly, the drawings included herein are diagrammatic representations of integrated circuit structures. Moreover, the drawings can show the structures to aid in understanding the illustrated examples.

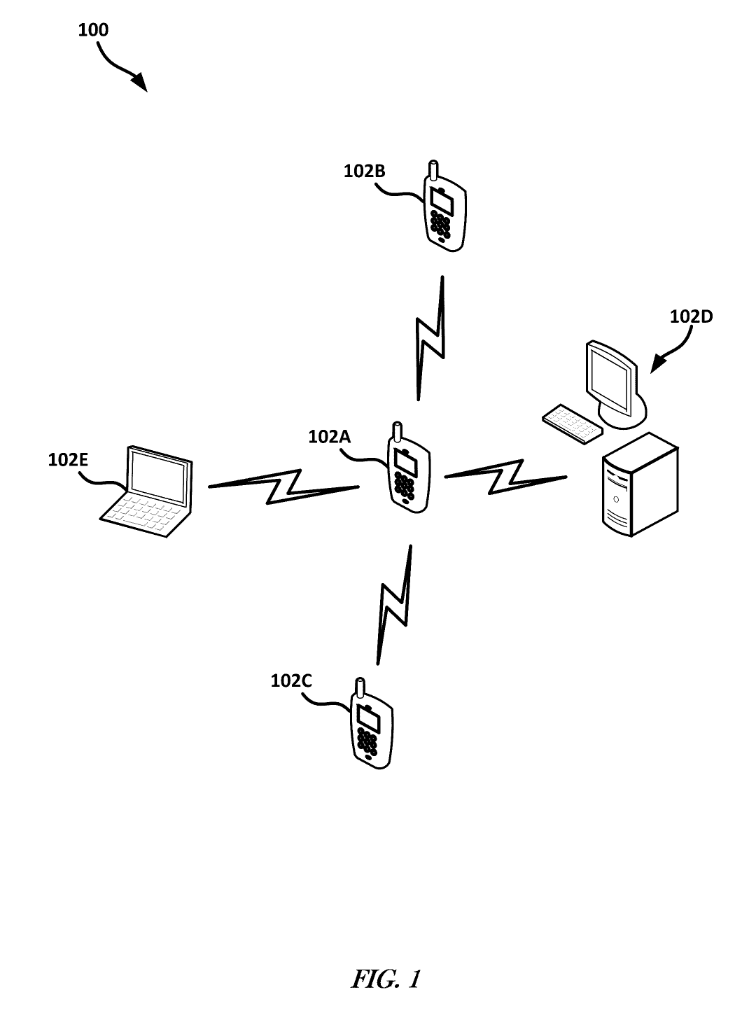

FIG. 1 shows an example of a system 100 configured in a distributed D2D communication architecture. System 100 can include one or more UEs 102A, 102B, 102C, 102D, and 102E configured to communicate with each other. One or more UEs 102B-102E can be trying to communicate with another UE 102A, such as at the same time or simultaneously. In this configuration, the UE 104A-E can maintain the communication links (e.g., with both data and control channels). A UE 102A-E can include a power control subsystem that meets one or more of the following criteria: 1) maintaining the communication link to at least one D2D partner; and 2) balancing the communication requirements and interference to neighbor, or other UEs 104A-E, such as with resource sharing.

A UE 102A-E can include a Personal Computer (PC) that may or may not be portable (e.g., a notebook or a netbook), a tablet, a Set-Top Box (STB), a gaming console, a Personal Digital Assistant (PDA), a mobile telephone or Smartphone, a web appliance, a network router, mobile broadband adapter, switch, or bridge, or other communication device.

The transmission power for D2D channels can be a function of the maximum allowable transmission power for the specific UE 102A-E antenna, the amount of bandwidth available (e.g., expressed as a transmission bandwidth factor), the noise or interference level on the D2D UE, a Signal to Interference/Noise Ratio (SINR), or a combination thereof.

In one or more embodiments, the decided transmission power (P_{D, ANT}) can be expressed as follows:

P_{D, Ant}^{dB}=MIN(P_{D2D,Max,Ant}^{dB}; 10 log₁₀(B)+NI^{dB}+SINR_{Target}^{dB}+L₀^{dB} (Equation 1)

Where P_{D, Ant} is the decided transmission power of the UE for each transmission antenna; P_{D2D, Max, Ant} is the maximum allowed transmission power of the UE for each transmission antenna; 10 log₁₀(B) is a transmission resource bandwidth factor (where B is the bandwidth); NI is the noise and interference power level on the paired UE; L₀ is the measured pathloss value within the D2D pair; and SINR_{Target} is the targeted received Signal to Interference and Noise Ration (SINR) in the D2D pair. All these quantities can be expressed in decibels. SIR and SINR can be linear quantities. A linear quantity, X, can be converted to decibels through the equation X^{dB}=10*log₁₀(X^{Linear}). The transmission resource bandwidth factor can be expressed as a number of Resource Blocks (RB), such as when the UE is communicating using an LTE cellular network. B can be different depending on the definition of NI. For example, if NI is defined as decibel-milliwatts/Hertz (dBm/Hz), B can be determined as a number of Hz; if NI is defined as dBm/RB, B can be determined as a number of RB; or if NI is defined as dBm/subcarrier, B can be determined as the number of subcarriers.

SINR_{Target}^{dB} can be determined by using the following process:

A UE can measure a Signal to Interference Ratio (SIR) of a received reference signal. The received reference signal SIR can be determined using Equation 2:

SIR_{Ref Sig}^{Linear}=(P_{S0,Rx}^{Linear})/Σᵢ₌₁^{N} P_{Si, Rx}^{Linear} (Equation 2)

Second, the SINR_{Target} can be determined using Equation 3:

SINR_{Target}^{Linear}=SIR_{Ref Sig}^{Linear}−1/Gᵣ (Equation 3)

Where Gᵣ≧1 and is a system parameter equal to the receiving UE processing gain.

The SINR_{Target} can be converted to decibels using Equation 4:

$${SINR}_{Target}^{dB} = \{ \begin{matrix}- ∞ , & if {SINR}_{Target}^{Linear} \leq 0 \\ 10 log 10 ( {SINR}_{Target}^{Linear} ) , & if {SINR}_{Target}^{Linear} > 0\end{matrix} \qquad ( Equation 4 )$$

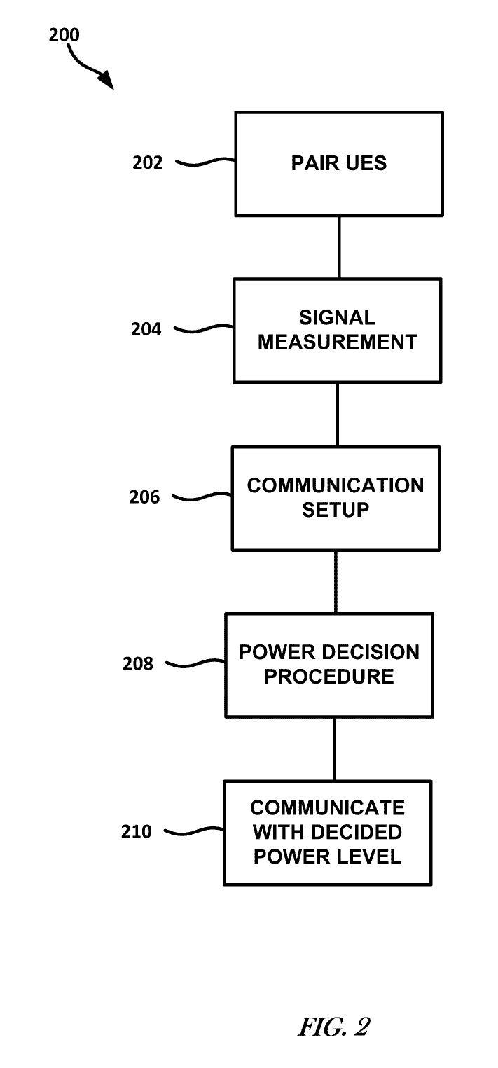

FIG. 2 is a block diagram of an example of a technique for deciding a transmission power. At 202, a first UE 102A can be paired with a second UE 102B. At 204, the UE 102A or 102B can measure one or more received reference signal's parameters. The parameters can include the SIR or other parameters. The reference signal can be a D2D signal used for D2D UE 102A-E discovery. The reference signal can be a sounding like signal, such as can be used for channel measurements, or other reference signal sent from one UE 102A-E to another UE 102A-E. The measured SIR can be used to determine the SINR for the paired combination of UEs 102A-E. SINR can be determined as detailed herein.

At 206, communication setup between the paired UE 102A-E can be performed. Communication setup can be different for different types of devices (e.g., UEs 102A-E) or devices with different hardware or software. Communication setup can include time or frequency synchronization or D2D channel initialization. The channel initialization can be different for different system configurations. In a typical channel initialization a symphonized channel (e.g., for time and frequency) can be setup. The control channel (e.g., one or more different types of control channels) can be setup and then data channels can be setup. Communication setup can include exchanging the power control parameters determined previously or otherwise known by the UE 102A. Other power control parameters exchanged can include the NI measured on the UE 102A-E. For example, if UE 102A and UE 102B are paired and exchanging power control parameters, UE 102A can send the NI to the UE 102B based on the received NI at the UE 102A. One or more parameters exchanged in the communication setup can be overwritten by the power decision procedure at 208.

At 208, the paired UEs 102A-E can determine what transmission power to use, such as based on the control parameters signaled in the communication setup, measured previously, or otherwise known by the UE 102A-E. The transmission power can be determined using one or more of Equations 1-4. At 210, the paired UEs 102A-E can communicate using the decided power level.

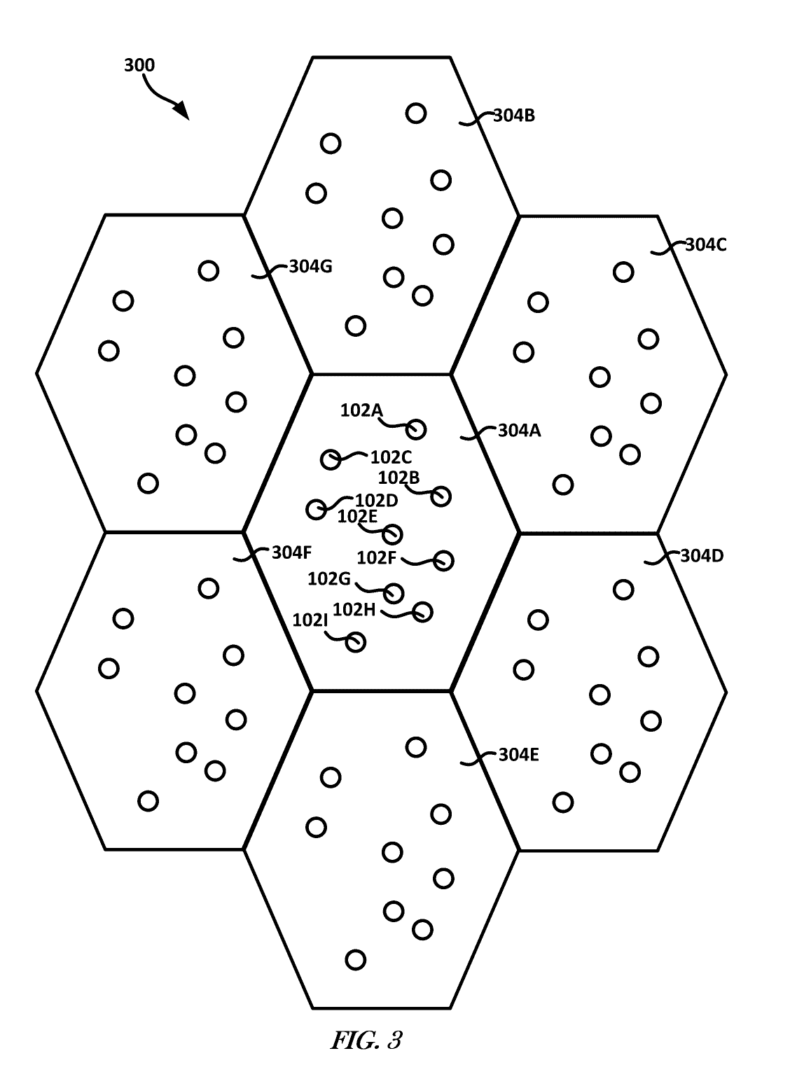

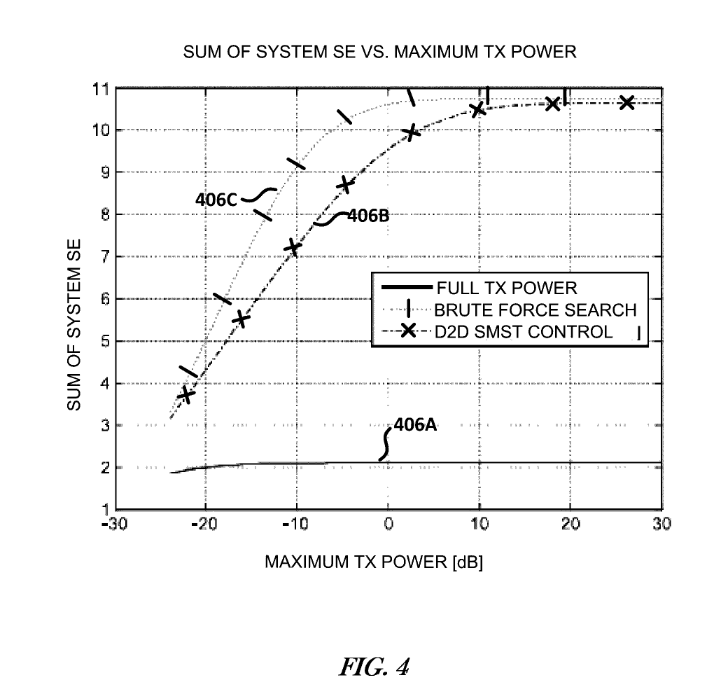

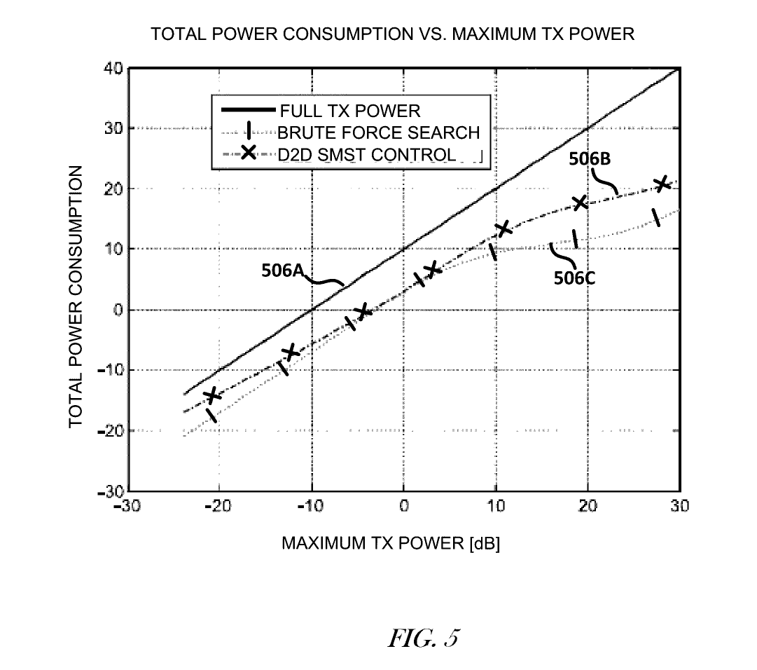

FIG. 3 shows illustrates an example of a system 300 that was used to evaluate the efficiency of a transmission power determination as discussed herein. Example results of the simulations are shown in FIGS. 4 and 5.

The simulation included seven cells 304A, 304B, 304C, 304D, 304E, 304F, and 304G, all of which are copies of each other. The simulation included several UEs 102A, 102B, 102C, 102D, 102E, 102F, 102G, 102H, and 102I. UEs 102A-I in the center cell 304A are paired randomly and communicating in the simulation. The copies of cell 304A, namely cells 304B-G, are modeled as inter-cluster interference sources creating a random, uniform noise distribution. The simulation includes the use of D2D channels including a configurable IMT-Advanced Indoor Hotspot with the NLoS as the default channel. The minimum D2D distance limitation used was about a half a meter.

FIG. 4 shows an example of a line graph detailing the sum of system Spectral Efficiency (SE) versus maximum transmit power in decibels. The SE for full (e.g., maximum) transmit power 406A, D2D Simplified Maximum Sector Throughput (SMST) control 406B (e.g., the transmission power determination techniques discussed herein) and a brute force search 406C are depicted in FIG. 4. The brute for search 406C is a search for the theoretically optimum solution. As can be seen in FIG. 4, the D2D SMST control 406B approaches the theoretically optimal brute force search 406C for transmission powers around 10 decibels. The D2D SMST control 406B has better SE than using the full transmit power 406A.

FIG. 5 shows an example of a line graph detailing the total power consumption versus the maximum transmit power in decibels. The total power consumption for full (e.g., maximum) transmit power 506A, D2D Simplified Maximum Sector Throughput (SMST) control 506B (e.g., the transmission power determination techniques discussed herein) and a brute force search 506C are depicted in FIG. 5. As can be seen in FIG. 5 the D2D SMST control 506B has less total power consumption than the full transmit power 506A, but greater than or equal total power consumption when compared with the theoretically optimal brute force search 506C.

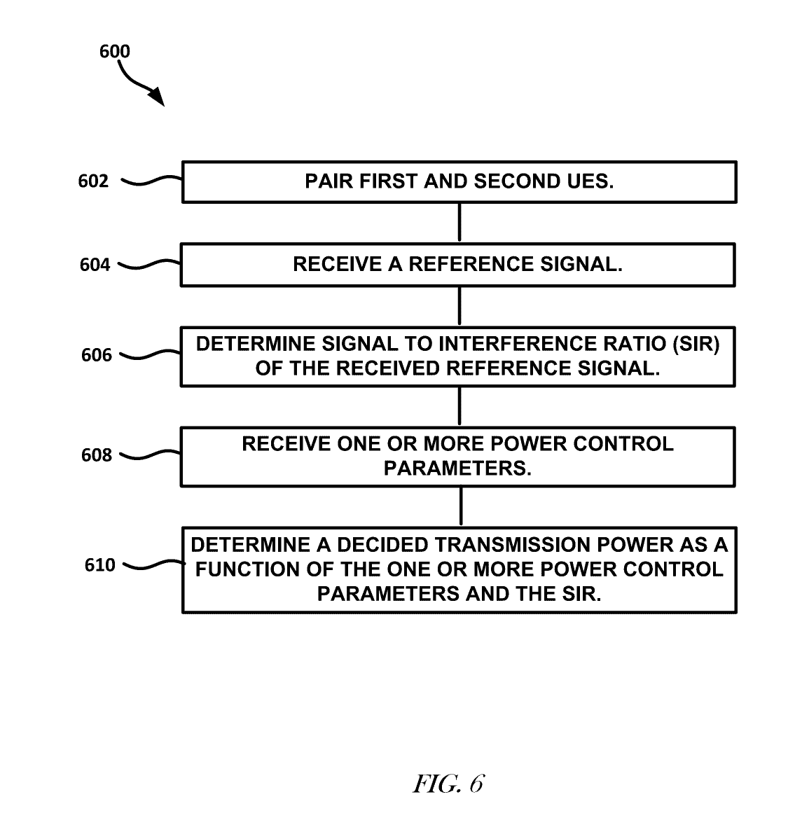

FIG. 6 shows an example of a technique 600 for determining a transmission power for a communication between two UEs 102A-E in a distributed or hybrid communication architecture system. At 602, the first UE 102A can be paired with the second UE 102B. At 604, a reference signal can be received.

At 606, an SIR of the received reference signal can be determined. At 608, one or more power control parameters can be received. The power control parameters can include an NI value of a transmission received at the first UE from the second UE. The technique 600 can include determining SINR as a function of the SIR and a signal processing gain of the first UE 102A. The technique 600 can include determining a transmission resource bandwidth factor for the first UE 102A. The technique 600 can include determining a path loss of a communication between the first UE 102A and the second UE 102B.

At 610, a decided transmission power can be determined as a function of the one or more power control parameters and the SIR. The transmission power can be determined as a function of the SINR. The transmission power can be determined further as a function of a maximum allowable transmission power of the first UE. The transmission power can be further determined as a function of a transmission resource bandwidth factor for the first UE 102A. The transmission power can be further determined as function of the determined path loss. The transmission power can be determined further as a minimum of (1) the maximum allowable transmission power and (2) a sum of the transmission resource bandwidth factor, the NI value, the measured path loss, and the SINR. The technique 600 can further include sending a communication from the first UE 102A to the second UE 102B using the decided transmission power.

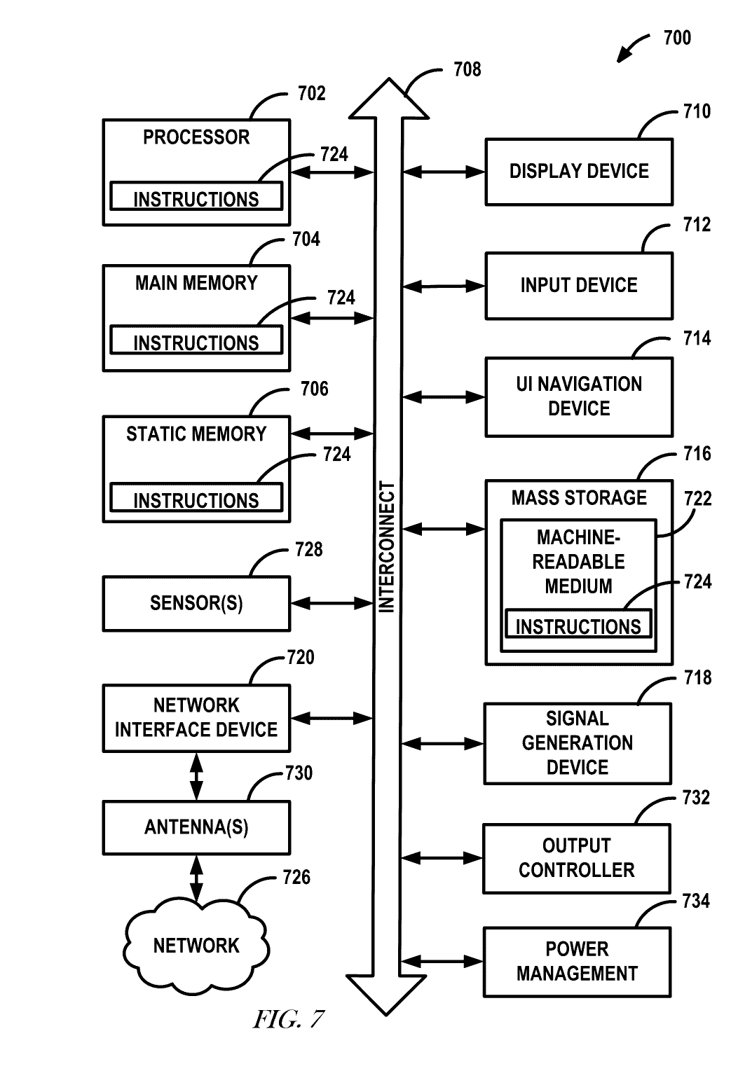

FIG. 7 is a block diagram illustrating an example computer system 700 machine upon which any one or more of the techniques herein discussed can be run. Such a computer system can be implemented in the UE 102A-E.

Computer system 700 can be a computing device, providing operations of the UE 102A-E. In an example, the machine can operate as a standalone device or can be connected (e.g., via a cellular network) to other machines. In a networked deployment, the machine can operate in the capacity of either a server or a client machine in server-client network environments, or it can act as a peer machine in peer-to-peer (or distributed) network environments. Further, while only a single machine is illustrated, the term “machine” shall also be taken to include any collection of machines that individually or jointly execute a set (or multiple sets) of instructions to perform any one or more of the methodologies discussed herein.

Example computer system 700 can include a processor 702 (e.g., a Central Processing Unit (CPU), a Graphics Processing Unit (GPU) or both), a main memory 704 and a static memory 706, which communicate with each other via an interconnect 708 (e.g., a link, a bus, etc.). The computer system 700 can further include a video display unit 710, an alphanumeric input device 712 (e.g., a keyboard), and a User Interface (UI) navigation device 714 (e.g., a mouse). In an example, the video display unit 710, input device 712 and UI navigation device 714 are a touch screen display. The computer system 700 can additionally include a storage device 716 (e.g., a drive unit), a signal generation device 718 (e.g., a speaker), an output controller 732, a power management controller 734, and a network interface device 720 (which can include or operably communicate with one or more antennas 730, transceivers, or other wireless communications hardware), and one or more sensors 728, such as a GPS sensor, compass, location sensor, accelerometer, or other sensor.

The storage device 716 can include a machine-readable medium 722 on which can be stored one or more sets of data structures and instructions 724 (e.g., software) embodying or utilized by any one or more of the methodologies or functions described herein. The instructions 724 can also reside, completely or at least partially, within the main memory 704, static memory 706, or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” can include a single medium or multiple media (e.g., a centralized or distributed database, and/or associated caches and servers) that store the one or more instructions 724. The term “machine-readable medium” shall also be taken to include any tangible medium that can be capable of storing, encoding or carrying instructions for execution by the machine and that cause the machine to perform any one or more of the methodologies of the present disclosure or that can be capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 724 can further be transmitted or received over a network (e.g., a distributed or hybrid distributed and centralized cellular network) using a transmission medium via the network interface device 720 utilizing any one of a number of well-known transfer protocols (e.g., OFDMA, SC-FDMA, TDMA, TDMA, CDMA, or other channel access method). The term “transmission medium” shall be taken to include any intangible medium that can be capable of storing, encoding, or carrying instructions for execution by the machine, and includes digital or analog communications signals or other intangible medium to facilitate communication of such software.

### EXAMPLES AND NOTES

The present subject matter may be described by way of several examples.

Example 1 can include or use subject matter (such as an apparatus, a method, a means for performing acts, or a device readable memory including instructions that, when performed by the device, can cause the device to perform acts), such as can include or use a UE including a computer processor, the processor configured to determine a transmission power for a device to device communication transmission between the UE and another UE, the transmission power determined based on a transmission bandwidth resource factor, a noise and interference power level of the communication between the UE and the another UE, and at least one of the group consisting of: (1) a maximum allowed transmission power, (2) a measured path loss of the communication between the UE and the another UE, and (3) a Signal to Interference plus Noise Ratio (SINR) of the communication from the UE to the another UE. Example 1 can optionally include or use a transceiver coupled to the processor and configured to communicate with the another UE in accord with the determined transmission power.

Example 2 can include or use, or can optionally be combined with the subject matter of Example 1, to optionally include or use wherein the communication includes a reference signal from the another UE. Example 2 can optionally include or use wherein the processor can be configured to determine the SINR of a reference signal received from the another UE or wherein the transmission power can be determined based on the determined SINR.

Example 3 can include or use, or can optionally be combined with the subject matter of Examples 1 or 2, to optionally include or use wherein measuring the SINR of the reference signal includes measuring an SIR of the reference signal and determining the SINR based on the SIR and a signal processing gain of the first UE.

Example 4 can include or use, or can optionally be combined with the subject matter of Example 1-3, to optionally include or use wherein the processor can be configured to perform a communication setup including at least one selected from the group consisting of: time synchronizing the UE and the another UE, frequency synchronizing the UE and the another UE, device to device channel initialization, and transmitting one or more power control parameters to the another UE.

Example 5 can include or use, or can optionally be combined with the subject matter of Example 1-4, to optionally include or use wherein the communication setup includes receiving one or more power control parameters and wherein the power control parameters include the noise and interference level of the UE.

Example 6 can include or use, or can optionally be combined with the subject matter of Example 1-5, to optionally include or use wherein the decided transmission power can be the minimum of (1) the maximum transmission power and (2) a sum of the transmission resource bandwidth factor, a noise and interference power level between the UE and the another UE, a measured path loss between the UE and the another UE, and the Signal to Interference plus Noise Ratio (SINR).

Example 7 can include or use, or can optionally be combined with the subject matter of Example 1-6, to optionally include or use wherein the decided transmission power can be a first decided transmission power and a power level of a communication between the UE and the another UE can be the minimum of (1) the first decided transmission power and (2) a second decided transmission power of the another UE decided in the same manner as the first transmission power.

Example 8 can include or use, or can be optionally be combined with the subject matter of at least one of Examples 1-7, to include subject matter (such as an apparatus, a method, a means for performing acts, or a device readable memory including instructions that, when performed by the device, can cause the device to perform acts), such as can include or use determining a transmission power level of a device to device communication between a first User Equipment (UE) and a second UE, the method including pairing the first UE with the second UE, receiving a reference signal, determining a Signal to Interference Ratio (SIR) of the received reference signal or receiving one or more power control parameters. Example 8 can optionally include or use determining a decided transmission power as a function of the one or more power control parameters and the SIR.

Example 9 can include or use, or can optionally be combined with the subject matter of Example 1-8, to optionally include or use determining a Signal to Interference Plus Noise Ratio (SINR) as a function of the SIR and a signal processing gain of the first UE and wherein determining the transmission power includes determining the transmission power further as a function of the SINR.

Example 10 can include or use, or can optionally be combined with the subject matter of Example 1-9, to optionally include or use wherein exchanging one or more control parameters includes receiving a Noise and Interference (NI) value at the first UE from the second UE and wherein determining the transmission power includes determining the transmission power further as a function of the NI value.

Example 11 can include or use, or can optionally be combined with the subject matter of Example 1-10, to optionally include or use wherein determining the transmission power includes determining the transmission power further as a function of a maximum allowable transmission power of the first UE.

Example 12 can include or use, or can optionally be combined with the subject matter of Example 1-11, to optionally include or use determining a transmission resource bandwidth factor for the first UE or determining a path loss of a communication between the first UE and the second UE. Example 12 can optionally include or use wherein determining the transmission power includes determining the transmission power further as a function of an available bandwidth for the first UE and the determined path loss.

Example 13 can include or use, or can optionally be combined with the subject matter of Example 1-12, to optionally include or use wherein determining the transmission power includes determining the transmission power further as a minimum of (1) the maximum allowable transmission power and (2) a sum of the transmission resource bandwidth factor, the NI value, the measured path loss, and the SINR.

Example 14 can include or use, or can optionally be combined with the subject matter of Example 1-13, to optionally include or use sending a communication from the first UE to the second UE using the decided transmission power.

Example 15 can include or use, or can be optionally be combined with the subject matter of at least one of Examples 1-14, to include subject matter (such as an apparatus, a method, a means for performing acts, or a device readable memory including instructions that, when performed by the device, can cause the device to perform acts), such as can include or use instructions configured to determine a transmission power level of a communication between a first User Equipment (UE) and a second UE stored thereon, the instructions, which when executed by a machine, cause the machine to perform operations including pairing the first UE with the second UE, receiving a reference signal, determining a Signal to Interference Ratio (SIR) of the received reference signal or receiving one or more power control parameters. Example 15 can optionally include or use determining a decided transmission power as a function of the one or more power control parameters and the SIR.

Example 16 can include or use, or can optionally be combined with the subject matter of Example 1-15, to optionally include or use instructions, which when executed by the machine cause the machine to perform operations including determining a Signal to Interference Plus Noise Ratio (SINR) as a function of the SIR and a signal processing gain of the first UE and wherein the instructions for determining the transmission power include instructions for determining the transmission power further as a function of the SINR.

Example 17 can include or use, or can optionally be combined with the subject matter of Example 1-16, to optionally include or use wherein the instructions for receiving one or more control parameters include instructions for receiving a Noise and Interference (NI) value at the first UE from the second UE. Example 17 can optionally include or use wherein the instructions for determining the transmission power include instructions determining the transmission power further as a function of the NI value.

Example 18 can include or use, or can optionally be combined with the subject matter of Example 1-17, to optionally include or use wherein the instructions for determining the transmission power include instructions for determining the transmission power further as a function of a maximum allowable transmission power of the first UE.

Example 19 can include or use, or can optionally be combined with the subject matter of Example 1-18, to optionally include or use instructions, which when executed by the machine, cause the machine to perform operations including determining a transmission resource bandwidth factor for the first UE or determining a path loss of a communication between the first UE and the second UE. Example 19 can optionally include or use wherein the instructions for determining the transmission power include instructions for determining the transmission power further as a function of an available bandwidth for the first UE and the determined path loss.

Example 20 can include or use, or can optionally be combined with the subject matter of Example 1-19, to optionally include or use wherein the instructions for determining the transmission power include instructions for determining the transmission power further as a minimum of (1) the maximum allowable transmission power and (2) a sum of the transmission resource bandwidth factor, the NI value, the measured path loss, and the SINR.

The above detailed description includes references to the accompanying drawings, which form a part of the detailed description. The drawings show, by way of illustration, specific embodiments in which methods, apparatuses, and systems discussed herein can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a “nonexclusive or” of the elements in the range {103A, 103B}, such that 103A-103B includes “103A but not 103B”, “103B but not 103A”, and “103A and 103B”.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1.-20. (canceled)

21. A User Equipment (UE) comprising:
a computer processor, the processor configured to determine a transmission power for a device to device communication transmission between the UE and another UE, the transmission power determined based on a transmission bandwidth resource factor, a noise and interference poser level of the communication between the UE and the another UE, and at least one of the group consisting of: (1) a maximum allowed transmission power, (2) a measured path loss of the communication between the UE and the another UE, and (3) a Signal to Interference plus Noise Ratio (SINR) of the communication from the UE to the another UE; and
a transceiver coupled to the processor and configured to communicate with the another UE in accord with the determined transmission power.

22. The UE of claim 21, wherein the communication includes a reference signal from the another UE and the processor is configured to determine the SINR of a reference signal received from the another UE and wherein the transmission power is determined based on the determined SINR.

23. The UE of claim 22, wherein measuring the SINR of the reference signal includes measuring a Signal to Interference Ratio (SIR) of the reference signal and determining the SINR based on the SIR and a signal processing gain of the first UE.

24. The UE of claim 22, wherein the processor is configured to perform a communication setup including at least one selected from the group consisting of: time synchronizing the UE and the another UE, frequency synchronizing the UE and the another UE, device to device channel initialization, and transmitting one or more power control parameters to the another UE.

25. The UE of claim 24, wherein the communication setup includes receiving one or more power control parameters and wherein the power control parameters include the noise and interference level of the UE.

26. The UE of claim 25, wherein the decided transmission power is the minimum of (1) the maximum transmission power and (2) a sum of the transmission resource bandwidth factor, a noise and interference power level between the UE and the another UE, a measured path loss between the UE and the another UE, and the Signal to Interference plus Noise Ratio (SINR).

27. The UE of claim 26, wherein the decided transmission power is a first decided transmission power and a power level of a communication between the UE and the another UE is the minimum of (1) the first decided transmission power and (2) a second decided transmission power of the another UE decided in the same manner as the first transmission power.

28. A method of determining a transmission power level of a device to device communication between a first User Equipment (UE) and a second UE, the method comprising:
pairing the first UE with the second UE;
receiving a reference signal;
determining a Signal to Interference Ratio (SIR) of the received reference signal;
receiving one or more power control parameters; and
determining a decided transmission power as a function of the one or more power control parameters and the SIR.

29. The method of claim 28, further comprising determining a Signal to Interference Plus Noise Ratio (SINR) as a function of the SIR and a signal processing gain of the first UE and wherein determining the transmission power includes determining the transmission power further as a function of the SINR.

30. The method of claim 29, wherein receiving one or more control parameters includes receiving a Noise and Interference (NI) value at the first UE from the second UE and wherein determining the transmission power includes determining the transmission power further as a function of the NI value.

31. The method of claim 30, wherein determining the transmission power includes determining the transmission power further as a function of a maximum allowable transmission power of the first UE.

32. The method of claim 31, further comprising:
determining a transmission resource bandwidth factor for the first UE;
determining a path loss of a communication between the first UE and the second UE; and
wherein determining the transmission power includes determining the transmission power further as a function of an available bandwidth for the first UE and the determined path loss.

33. The method of claim 32, wherein determining the transmission power includes determining the transmission power further as a minimum of (1) the maximum allowable transmission power and (2) a sum of the transmission resource bandwidth factor, the NI value, the measured path loss, and the SINR.

34. The method of claim 33, further comprising sending a communication from the first UE to the second UE using the decided transmission power.

35. A computer readable storage device including instructions configured to determine a transmission power level of a communication between a first User Equipment (UE) and a second UE stored thereon, the instructions, which when executed by a machine, cause the machine to perform operations comprising:
pairing the first UE with the second UE;
receiving a reference signal;
determining a Signal to Interference Ratio (SIR) of the received reference signal;
receiving one or more power control parameters; and
determining a decided transmission power as a function of the one or more power control parameters and the SIR.

36. The storage device of claim 35, further comprising instructions, which when executed by the machine cause the machine to perform operations comprising: determining a Signal to Interference Plus Noise Ratio (SINR) as a function of the SIR and a signal processing gain of the first UE and wherein the instructions for determining the transmission power include instructions for determining the transmission power further as a function of the SINR.

37. The storage device of claim 36, wherein:
the instructions for receiving one or more control parameters include instructions for receiving a Noise and Interference (NI) value at the first UE from the second UE; and
the instructions for determining the transmission power include instructions determining the transmission power further as a function of the NI value.

38. The storage device of claim 37, wherein the instructions for determining the transmission power include instructions for determining the transmission power further as a function of a maximum allowable transmission power of the first UE.

39. The storage device of claim 38, further comprising instructions, which when executed by the machine, cause the machine to perform operations comprising:
determining a transmission resource bandwidth factor for the first UE;
determining a path loss of a communication between the first UE and the second UE; and
wherein the instructions for determining the transmission power include instructions for determining the transmission power further as a function of an available bandwidth for the first UE and the determined path loss.

40. The storage device of claim 39, wherein the instructions for determining the transmission power include instructions for determining the transmission power further as a minimum of (1) the maximum allowable transmission power and (2) a sum of the transmission resource bandwidth factor, the NI value, the measured path loss, and the SINR.
